(19) United States
(12) Patent Application Publication
(10) Pub. No.: US 2012/0228851 A1
(43) Pub. Date: Sep. 13, 2012

(54) Bicycle Whose Front Wheel Can Be Adjusted To A Deviated Position

(76) Inventor: Jui-Min Chen, Taichung City (TW)

(21) Appl. No.: 13/042,582

(22) Filed: Mar. 8, 2011

(51) Int. Cl. B62K 25/00

(52) U.S. Cl. 280/287

(57) ABSTRACT

A bicycle includes a front wheel, a wheel axle mounted on the front wheel, a front fork located above the wheel axle, two front fork ends each mounted on the front fork and each connected with the wheel axle, and two adjusting shims each mounted on a respective one of the front fork ends. Each of the front fork ends has a lower end provided with a mounting recess for mounting the wheel axle. Each of the adjusting shims has a lower end provided with an adjusting recess secured on the wheel axle. Thus, the wheel axle is deviated from the front fork by adjustment of the adjusting shims so that the distance between the wheel axle and the front fork can be adjusted, and the front wheel is available for an inclined road and an even road.

### BACKGROUND OF THE INVENTION

1. Field of the Invention

The present invention relates to a wheeled vehicle and, more particularly, to a bicycle.

2. Description of the Related Art

A conventional bicycle 7 in accordance with the prior art shown in FIG. 14 comprises a front wheel 72, a wheel axle 75 mounted on the front wheel 72, a front fork 71 located above the wheel axle 75, and two front fork ends 74 each mounted on the lower end of the front fork 71 and each hooked onto the wheel axle 75. Each of the two front fork ends 74 has an axial line 76 passing through the center of the wheel axle 75. The axial line 76 of each of the two front fork ends 74 is inclined relative to the axial line 77 of the front fork 71, and an angle “d” is defined between the axial line 76 of each of the two front fork ends 74 and the axial line 77 of the front fork 71. However, each of the two front fork ends 74 is fixed between the front fork 71 and the wheel axle 75 so that the angle “d” between the axial line 76 of each of the two front fork ends 74 and the axial line 77 of the front fork 71 is fixed. Thus, the distance between the front fork 71 and the wheel axle 75 is fixed and cannot be adjusted so that the front wheel 72 is only available for an inclined road or an even road and cannot be adapted for an inclined road and an even road.

### BRIEF SUMMARY OF THE INVENTION

In accordance with the present invention, there is provided a bicycle, comprising a front wheel, a wheel axle mounted on the front wheel, a front fork located above the wheel axle, two front fork ends each mounted on a lower end of the front fork and each connected with the wheel axle, and two adjusting shims each mounted on a respective one of the two front fork ends and each clamping the wheel axle. Each of the two front fork ends has a lower end provided with a mounting recess for mounting the wheel axle. Each of the two adjusting shims has a lower end provided with an adjusting recess secured on the wheel axle. The adjusting recess of each of the two adjusting shims is connected to the mounting recess of the respective front fork end.

The primary objective of the present invention is to provide a bicycle whose front wheel can be adjusted to a deviated position.

According to the primary advantage of the present invention, the wheel axle is deviated from the front fork by adjustment of the adjusting shims so that the distance between the wheel axle and the front fork can be adjusted, and the front wheel is available for an inclined road and an even road.

According to another advantage of the present invention, each of the two front fork ends has at least one positioning hole, and each of the two adjusting shims has at least one positioning stub positioned in the positioning hole of the respective front fork end so that each of the two adjusting shims is combined with the respective front fork end solidly and stably.

According to a further advantage of the present invention, each of the two adjusting shims has an insert inserted into the mounting recess of the respective front fork end to enhance the structural strength of each of the two adjusting shims and the respective front fork end.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a side view of a bicycle in accordance with the preferred embodiment of the present invention.

FIG. 2 is a partially exploded perspective view of the bicycle as shown in FIG. 1.

FIG. 3 is a side assembly view of the bicycle as shown in FIG. 2.

FIG. 4 is a partially side assembly view of the bicycle as shown in FIG. 1

FIG. 5 is a cross-sectional view of the bicycle taken along line 5-5 as shown in FIG. 4.

FIG. 6 is a locally enlarged side view of a bicycle in accordance with another preferred embodiment of the present invention.

FIG. 7 is a locally enlarged side view of a bicycle in accordance with another preferred embodiment of the present invention.

FIG. 8 is an exploded perspective view of a bicycle in accordance with another preferred embodiment of the present invention.

FIG. 9 is a side assembly view of the bicycle as shown in FIG. 8.

FIG. 10 is a partially side assembly view of the bicycle as shown in FIG. 9.

FIG. 11 is a cross-sectional view of the bicycle taken along line 11-11 as shown in FIG. 10.

FIG. 12 is a locally enlarged side view of a bicycle in accordance with another preferred embodiment of the present invention.

FIG. 13 is a locally enlarged side view of a bicycle in accordance with another preferred embodiment of the present invention.

FIG. 14 is a side view of a conventional bicycle in accordance with the prior art.

### DETAILED DESCRIPTION OF THE INVENTION

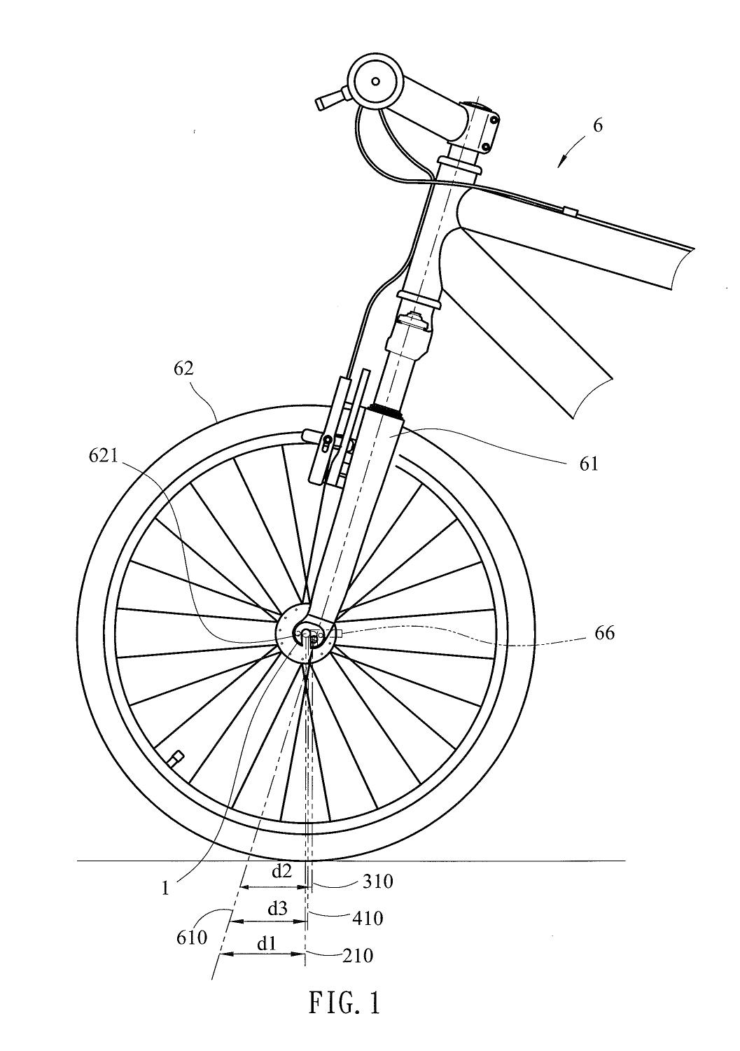

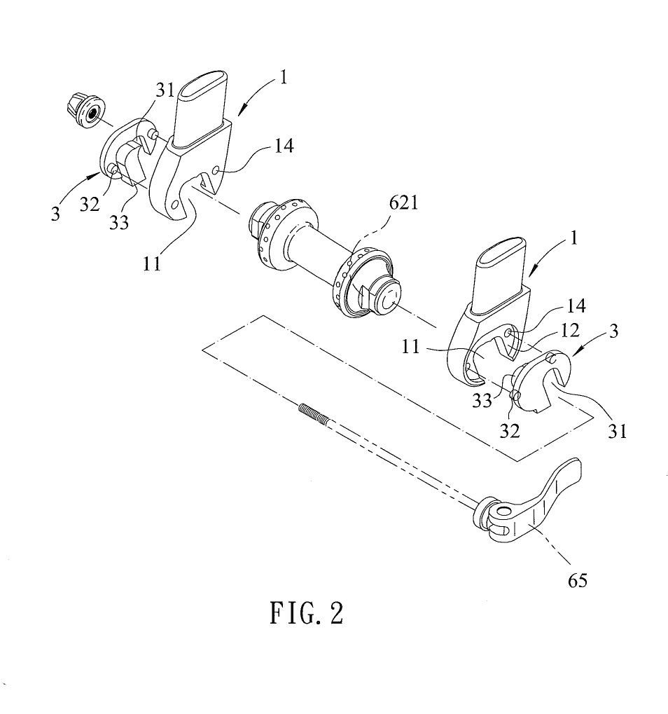

Referring to the drawings and initially to FIGS. 1-5, a bicycle 6 in accordance with the preferred embodiment of the present invention comprises a front wheel 62, a wheel axle 621 mounted on the front wheel 62, a front fork 61 located above the wheel axle 621, two front fork ends 1 each mounted on a lower end of the front fork 61 and each connected with the wheel axle 621, two adjusting shims 3 each mounted on a respective one of the two front fork ends 1 and each clamping the wheel axle 621, and a quick release 65 extended through the two adjusting shims 3, the two front fork ends 1 and the wheel axle 621 to lock the two adjusting shims 3 and the two front fork ends 1 onto the wheel axle 621.

Each of the two front fork ends 1 is located between the wheel axle 621 and the respective adjusting shim 3. Each of the two front fork ends 1 has a lower end provided with a mounting recess 11 for mounting the wheel axle 621 and has a side provided with a receiving groove 12 to receive the respective adjusting shim 3. The receiving groove 12 of each of the two front fork ends 1 has a size greater than that of the mounting recess 11.

Each of the two adjusting shims 3 is received in the receiving groove 12 of the respective front fork end 1 and has a shape corresponding to that of the receiving groove 12 of the respective front fork end 1. Each of the two adjusting shims 3 has a lower end provided with an adjusting recess 31 secured on the wheel axle 621. The adjusting recess 31 of each of the two adjusting shims 3 is connected to the mounting recess 11 of the respective front fork end 1. The adjusting recess 31 of each of the two adjusting shims 3 has a width that is smaller than that of the mounting recess 11 of the respective front fork end 1 and is equal to a diameter of the wheel axle 621. The adjusting recess 31 of each of the two adjusting shims 3 is disposed at an inner side of the mounting recess 11 of the respective front fork end 1 so that the wheel axle 621 is disposed at the inner side of the mounting recess 11 of the respective front fork end 1.

In the preferred embodiment of the present invention, the receiving groove 12 of each of the two front fork ends 1 has a substantially oblong shape, and each of the two adjusting shims 3 has a substantially oblong shape. Each of the two front fork ends 1 has a peripheral wall provided with at least one positioning hole 14. Each of the two adjusting shims 3 has a peripheral wall provided with at least one positioning stub 32 inserted into and positioned in the positioning hole 14 of the respective front fork end 1 so that each of the two adjusting shims 3 is combined with the respective front fork end 1 solidly and stably. Each of the two adjusting shims 3 has a side provided with an insert 33 inserted into the mounting recess 11 of the respective front fork end 1 to enhance the structural strength of each of the two adjusting shims 3 and the respective front fork end 1.

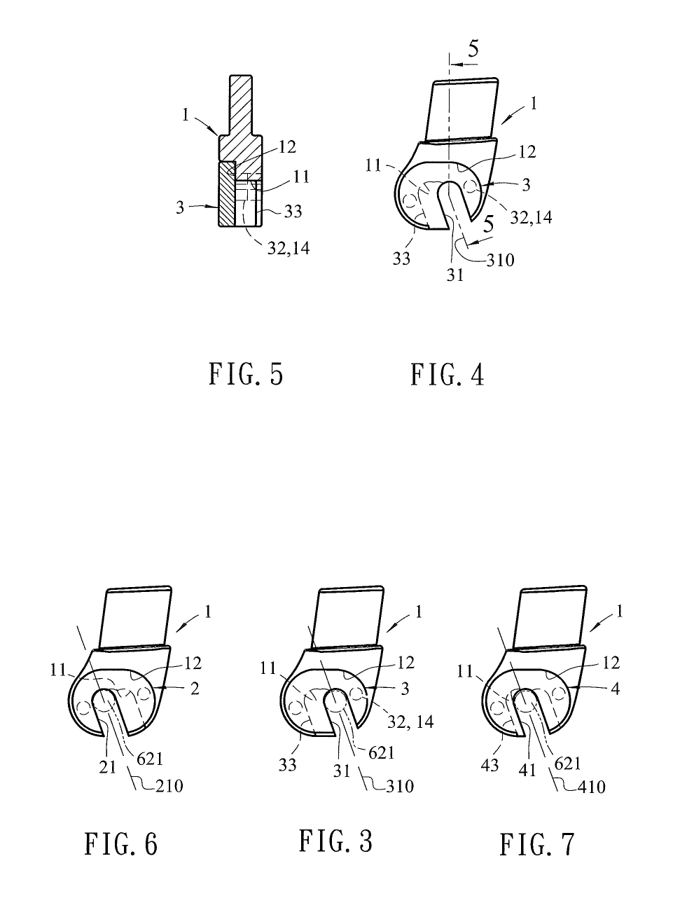

Referring to FIGS. 3-5 with reference to FIG. 1, the adjusting recess 31 of each of the two adjusting shims 3 has an axial line 310 passing through a center of the wheel axle 621. The axial line 310 of each of the two adjusting shims 3 is inclined relative to an axial line 610 of the front fork 61, and an angle “d2” is defined between the axial line 310 of each of the two adjusting shims 3 and the axial line 610 of the front fork 61. At this time, the adjusting recess 31 of each of the two adjusting shims 3 is disposed the inner side of the mounting recess 11 of the respective front fork end 1 so that the wheel axle 621 is disposed at the inner side of the mounting recess 11 of the respective front fork end 1. Thus, the wheel axle 621 is deviated rearward relative to the front fork 61 to the innermost position so that the front wheel 62 is deviated rearward relative to the front fork 61 to the innermost position. In such a manner, the front wheel 62 is deviated to the innermost position by adjustment of the two adjusting shims 3 so that the front wheel 62 is available for a road with a larger slope.

Referring to FIG. 6 with reference to FIG. 1, the adjusting recess 21 of each of the two adjusting shims 2 has an axial line 210 passing through the center of the wheel axle 621. The axial line 210 of each of the two adjusting shims 2 is inclined relative to the axial line 610 of the front fork 61, and an angle “d1” is defined between the axial line 210 of each of the two adjusting shims 2 and the axial line 610 of the front fork 61. At this time, the adjusting recess 21 of each of the two adjusting shims 2 is disposed an outer side of the mounting recess 11 of the respective front fork end 1 so that the wheel axle 621 is disposed at the outer side of the mounting recess 11 of the respective front fork end 1. Thus, the wheel axle 621 is deviated forward relative to the front fork 61 to the outermost position so that the front wheel 62 is deviated forward relative to the front fork 61 to the outermost position. In such a manner, the front wheel 62 is deviated to the outermost position by adjustment of the two adjusting shims 2 so that the front wheel 62 is available for an even road.

Referring to FIG. 7 with reference to FIG. 1, the adjusting recess 41 of each of the two adjusting shims 4 has an axial line 410 passing through the center of the wheel axle 621. The axial line 410 of each of the two adjusting shims 4 is inclined relative to the axial line 610 of the front fork 61, and an angle “d3” is defined between the axial line 410 of each of the two adjusting shims 4 and the axial line 610 of the front fork 61. At this time, the adjusting recess 41 of each of the two adjusting shims 4 is disposed a middle position of the mounting recess 11 of the respective front fork end 1 so that the wheel axle 621 is disposed at the middle position of the mounting recess 11 of the respective front fork end 1. Thus, the wheel axle 621 and the front wheel 62 are adjusted to the middle position. In such a manner, the front wheel 62 is deviated to the middle position by adjustment of the two adjusting shims 4 so that the front wheel 62 is available for a road with a smaller slope or an even road.

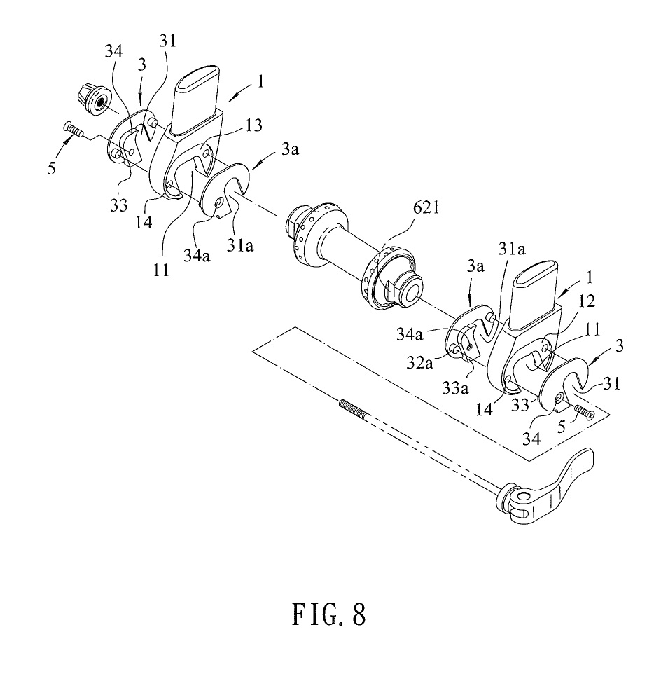

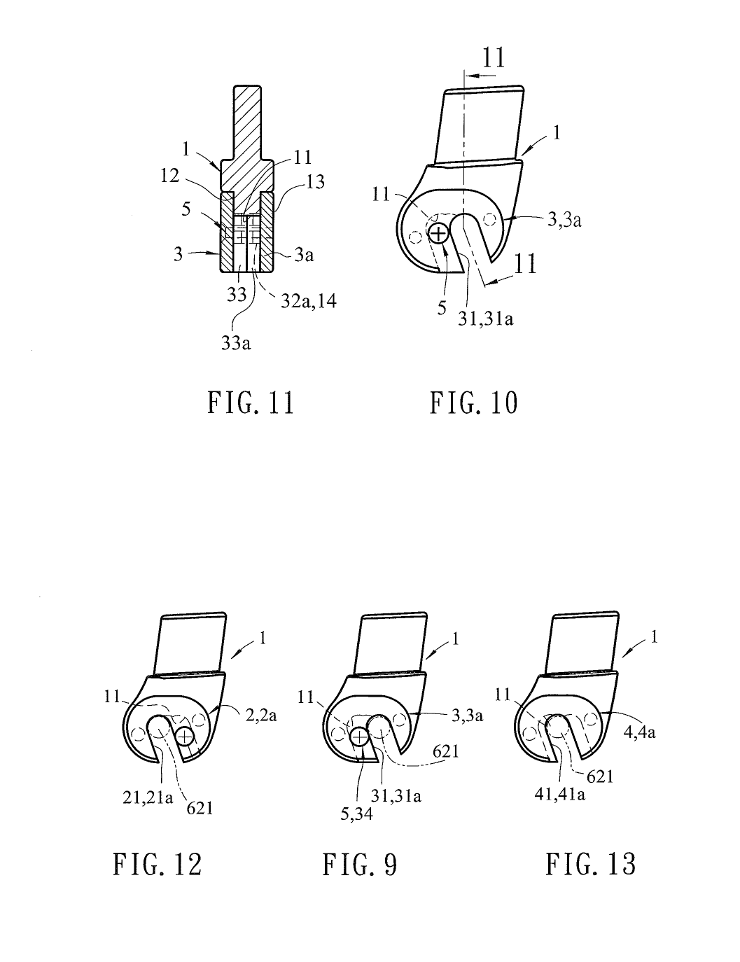

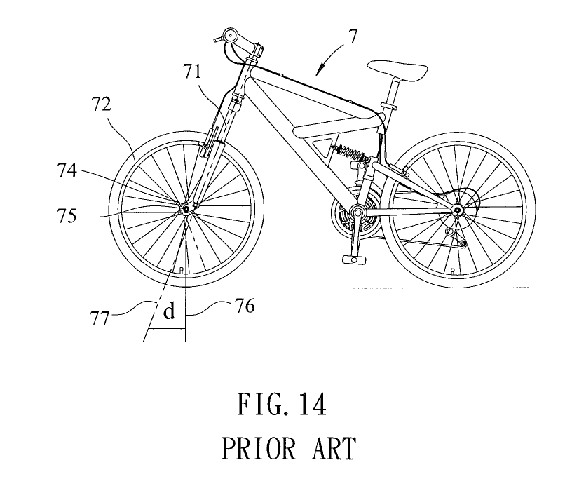

Referring to FIGS. 8-11, the bicycle 6 further comprises two reinforcing shims 3a each mounted on a respective one of the two front fork ends 1 and each clamping the wheel axle 621.

Each of the two front fork ends 1 is located between the respective adjusting shim 3 and the respective reinforcing shim 3a. Each of the two front fork ends 1 has a surface provided with a receiving depression 13 to receive the respective reinforcing shim 3a. The receiving depression 13 of each of the two front fork ends 1 has a size greater than that of the mounting recess 11.

Each of the two reinforcing shims 3a is received in the receiving depression 13 of the respective front fork end 1 and has a shape corresponding to that of the receiving depression 13 of the respective front fork end 1. Each of the two reinforcing shims 3a has a lower end provided with an adjusting opening 31a secured on the wheel axle 621. The adjusting opening 31a of each of the two reinforcing shims 3a is connected to the mounting recess 11 of the respective front fork end 1 so that the mounting recess 11 of each of the two front fork ends 1 is connected between the adjusting recess 31 of the respective adjusting shim 3 and the adjusting opening 31a of the respective reinforcing shim 3a. The adjusting opening 31a of each of the two reinforcing shims 3a is aligned with the adjusting recess 31 of the respective adjusting shim 3 and has a width which is equal to that of the adjusting recess 31 of the respective adjusting shim 3. The adjusting opening 31a of each of the two reinforcing shims 3a is disposed at the inner side of the mounting recess 11 of the respective front fork end 1.

In the preferred embodiment of the present invention, the receiving depression 13 of each of the two front fork ends 1 has a substantially oblong shape, and each of the two reinforcing shims 3a has a substantially oblong shape. Each of each of the two front fork ends 1 has a peripheral wall provided with at least one positioning hole 14. Each of the two reinforcing shims 3a has a peripheral wall provided with at least one positioning stub 32a inserted into and positioned in the positioning hole 14 of the respective front fork end 1 so that each of the two reinforcing shims 3a is combined with the respective front fork end 1 solidly and stably. Each of the two reinforcing shims 3a has a side provided with an insert 33a inserted into the mounting recess 11 of the respective front fork end 1 to enhance the structural strength of each of the two reinforcing shims 3a and the respective front fork end 1. Each of the two adjusting shims 3 has a surface provided with a through hole 34, each of the two reinforcing shims 3a has a surface provided with a screw bore 34a, and the bicycle 6 further comprises two locking screws 5 each extending through the through hole 34 of a respective one of the two adjusting shims 3 and each screwed into the screw bore 34a of a respective one of the two reinforcing shims 3a to combine the respective adjusting shim 3 with the respective reinforcing shim 3a.

Referring to FIG. 12, the adjusting opening 21a of each of the two reinforcing shims 2a is disposed at the outer side of the mounting recess 11 of the respective front fork end 1.

Referring to FIG. 13, the adjusting opening 41a of each of the two reinforcing shims 4a is disposed at the middle position of the mounting recess 11 of the respective front fork end 1.

Accordingly, the wheel axle 621 is deviated from the front fork 61 by adjustment of the adjusting shims 2, 3 or 4 so that the distance between the wheel axle 621 and the front fork 61 can be adjusted, and the front wheel 62 is available for an inclined road and an even road. In addition, each of the two front fork ends 1 has at least one positioning hole 14, and each of the two adjusting shims 3 has at least one positioning stub 32 positioned in the positioning hole 14 of the respective front fork end 1 so that each of the two adjusting shims 3 is combined with the respective front fork end 1 solidly and stably. Further, each of the two adjusting shims 3 has an insert 33 inserted into the mounting recess 11 of the respective front fork end 1 to enhance the structural strength of each of the two adjusting shims 3 and the respective front fork end 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

The invention claimed is:

1. A bicycle, comprising:
a front wheel;
a wheel axle mounted on the front wheel;
a front fork located above the wheel axle;
two front fork ends each mounted on a lower end of the front fork and each connected with the wheel axle; and
two adjusting shims each mounted on a respective one of the two front fork ends and each clamping the wheel axle;
wherein each of the two front fork ends has a lower end provided with a mounting recess for mounting the wheel axle;
each of the two adjusting shims has a lower end provided with an adjusting recess secured on the wheel axle;
the adjusting recess of each of the two adjusting shims is connected to the mounting recess of the respective front fork end.

2. The bicycle of claim 1, wherein the adjusting recess of each of the two adjusting shims has a width that is smaller than that of the mounting recess of the respective front fork end and is equal to a diameter of the wheel axle.

3. The bicycle of claim 1, wherein the adjusting recess of each of the two adjusting shims is disposed at an inner side of the mounting recess of the respective front fork end so that the wheel axle is disposed at the inner side of the mounting recess of the respective front fork end.

4. The bicycle of claim 1, wherein the adjusting recess of each of the two adjusting shims is disposed an outer side of the mounting recess of the respective front fork end so that the wheel axle is disposed at the outer side of the mounting recess of the respective front fork end.

5. The bicycle of claim 1, wherein the adjusting recess of each of the two adjusting shims is disposed a middle position of the mounting recess of the respective front fork end so that the wheel axle is disposed at the middle position of the mounting recess of the respective front fork end.

6. The bicycle of claim 1, wherein
each of the two front fork ends has a side provided with a receiving groove to receive the respective adjusting shim;
each of the two adjusting shims is received in the receiving groove of the respective front fork end;
each of the two adjusting shims has a shape corresponding to that of the receiving groove of the respective front fork end;
the receiving groove of each of the two front fork ends has a substantially oblong shape;
each of the two adjusting shims has a substantially oblong shape.

7. The bicycle of claim 1, wherein
each of the two front fork ends has a peripheral wall provided with at least one positioning hole;
each of the two adjusting shims has a peripheral wall provided with at least one positioning stub inserted into and positioned in the positioning hole of the respective front fork end so that each of the two adjusting shims is combined with the respective front fork end.

8. The bicycle of claim 1, wherein each of the two adjusting shims has a side provided with an insert inserted into the mounting recess of the respective front fork end.

9. The bicycle of claim 1, wherein
each of the two front fork ends is located between the wheel axle and the respective adjusting shim;
the receiving groove of each of the two front fork ends has a size greater than that of the mounting recess.

10. The bicycle of claim 1, wherein
the bicycle further comprises two reinforcing shims each mounted on a respective one of the two front fork ends and each clamping the wheel axle;
each of the two reinforcing shims has a lower end provided with an adjusting opening secured on the wheel axle;
the adjusting opening of each of the two reinforcing shims is aligned with the adjusting recess of the respective adjusting shim and has a width which is equal to that of the adjusting recess of the respective adjusting shim.

11. The bicycle of claim 10, wherein
each of the two front fork ends has a surface provided with a receiving depression to receive the respective reinforcing shim;
each of the two reinforcing shims is received in the receiving depression of the respective front fork end.

12. The bicycle of claim 11, wherein the
each of the two reinforcing shims has a shape corresponding to that of the receiving depression of the respective front fork end;
the receiving depression of each of the two front fork ends has a substantially oblong shape;
each of the two reinforcing shims has a substantially oblong shape.

13. The bicycle of claim 10, wherein the adjusting opening of each of the two reinforcing shims is connected to the mounting recess of the respective front fork end so that the mounting recess of each of the two front fork ends is connected between the adjusting recess of the respective adjusting shim and the adjusting opening of the respective reinforcing shim.

14. The bicycle of claim 10, wherein the adjusting opening of each of the two reinforcing shims is disposed at an inner side of the mounting recess of the respective front fork end.

15. The bicycle of claim 10, wherein the adjusting opening of each of the two reinforcing shims is disposed at an outer side of the mounting recess of the respective front fork end.

16. The bicycle of claim 10, wherein the adjusting opening of each of the two reinforcing shims is disposed at a middle position of the mounting recess of the respective front fork end.

17. The bicycle of claim 10, wherein
each of each of the two front fork ends has a peripheral wall provided with at least one positioning hole;
each of the two adjusting shims has a peripheral wall provided with at least one positioning stub inserted into and positioned in the positioning hole of the respective front fork end so that each of the two adjusting shims is combined with the respective front fork end;
each of the two reinforcing shims has a peripheral wall provided with at least one positioning stub inserted into and positioned in the positioning hole of the respective front fork end so that each of the two reinforcing shims is combined with the respective front fork end.

18. The bicycle of claim 10, wherein each of the two reinforcing shims has a side provided with an insert inserted into the mounting recess of the respective front fork end.

19. The bicycle of claim 10, wherein
each of the two adjusting shims has a surface provided with a through hole;
each of the two reinforcing shims has a surface provided with a screw bore;
the bicycle further comprises two locking screws each extending through the through hole of a respective one of the two adjusting shims and each screwed into the screw bore of a respective one of the two reinforcing shims to combine the respective adjusting shim with the respective reinforcing shim.

20. The bicycle of claim 11, wherein
each of the two front fork ends is located between the respective adjusting shim and the respective reinforcing shim;
the receiving depression of each of the two front fork ends has a size greater than that of the mounting recess.
